(19) United States
(12) Patent Application Publication
(10) Pub. No.: US 2026/0126259 A1
(43) Pub. Date: May 7, 2026

(54) APPARATUS, SYSTEMS, AND METHODS FOR PROVIDING ELECTRIC POWERED SIMULATED FIREARM EFFECTS AND EXTERNAL SIMULATION DATA INTERFACE

(71) Applicant: THREAT TEC, LLC, Hampton, VA (US)

(72) Inventors: James T. CRAWFORD, Hampton, VA (US); Andrew TIETZ, Hampton, VA (US)

(21) Appl. No.: 19/118,489

(22) PCT Filed: Oct. 10, 2023
(86) PCT No.: PCT/US2023/076477

§ 371 Date: Apr. 4, 2025

Related U.S. Application Data
(60) Provisional application No. 63/414,771, filed on Oct. 10, 2022.

(51) Int. Cl. F41A 33/06; F41A 33/02; F41A 33/04

(52) U.S. Cl. CPC F41A 33/06; F41A 33/02; F41A 33/04

(57) ABSTRACT

Realistic physical weapon effects (e.g., haptic, audio, visual), when a user activates the trigger of a connected firearm simulator. Physical weapon effects include blowback, recoil, cartridge ejection, muzzle flash, muzzle rapport, and so on, but without bullet discharge or other potentially dangerous effects. Firearm simulators are especially useful for training military and law enforcement in various scenarios, providing a more realistic environment. The present approach advantageously enhances firearm simulators through the integration of realistic physical weapon effects that may be modified or tuned to different simulation weapons and different conditions.

### CROSS REFERENCE TO RELATED APPLICATIONS

None.

### STATEMENT REGARDING GOVERNMENT SUPPORT

None.

### FIELD

The present disclosure relates to apparatus, systems, and methods for providing electric powered simulated firearm effects, including haptics, visual, and audio effects, and an external simulation data interface.

### BACKGROUND-INTRODUCTION

Firearm training is an important element of safe and effective possession and use of firearms, for the military, law enforcement, and private citizens. Training with live firearms involves various risks and costs, especially if using live ammunition. Using blank ammunition (i.e., a cartridge without a projectile or bullet), is useful, but carries a significant cost. Further, the risk of accidentally including a live cartridge cannot be ignored.

The use of firearm simulators has become common for training, particularly, military and law enforcement. Firearm simulators are designed to look and feel comparable to a genuine firearm, but do not operate in a manner that projects a bullet. Instead, the firearm simulator includes a mechanism to simulate the action of the particular firearm. Although useful, there is a considerable difference between firearm simulators and their genuine counterparts. For example, the bolt action, muzzle rapport and flash, cartridge ejection mechanism, and other aspects, are easily distinguishable.

What is needed, then, is an improved firearm simulator that provides physical effects—movement, sound, and light—that more closely resembles the genuine firearm.

### BRIEF SUMMARY

Described herein are apparatus, systems, and methods for providing electric powered simulated firearm effects with an integrated external simulation data interface. Preferred embodiments are referred to as the E-Sim Fire system, or simply E-Sim Fire.

The E-Sim Fire system enables realistic physical weapon effects (haptic, audio, visual) and sends weapon function information (round fired, charging handle positions, cover state, loaded state, orientation) through a simulator data interface which connects to a simulator control module. In some embodiments, the simulator control module is operating on an external electronic device, such as a computer or smart device. When a trigger on the weapon simulator is pressed, this closes a circuit which in turn sends power into a rate of fire control which powers the various weapon effect modules at a variable cycle rate. The rate of fire control enables the user to adjust the on and off time of the cycle to tune it to specific weapon profile the system is mounted to.

The Haptic module simulates the bolt movement through use of an electromagnetic coil that pulls a weighted rod with linear force when powered and a spring that returns the recoil when unpowered simulating the physical recoil of weapon. The Visual module simulates the visual signature of the sim fire event through a combination white and amber LEDs, fisheye lens reflectors and control ionized water vapor to create a physical 3D muzzle flare effect. The Audio module simulates the sound of the sim fire event by playing a playing recorded sound of the weapon system connected through an amplifier and tied to bass shaker style speakers mounted the front and rear of the receiver which times the sound to resonate through the simulator in physical sequence with the simulated bolt movement.

The weapon function information is sent through a series of switches for each weapon function to be tracked that are tied into the simulator data interface single multi-wire plug interface that enables a simulation interfaced with this to know when the simulator fires a round, when the top cover is open, when a charging action happens, and/or when a round is loaded. Additionally, the data interface accepts an input that can arm or disarm the system based on the simulation, i.e., if the simulation says the user is out of rounds then the simulator will not fire until the user reloads the simulator and works through the required charging sequence.

Embodiments of the present approach enable realistic physical weapon effects (including, e.g., haptic, audio, visual) when a user presses the trigger of a connected simulated firearm. One or more firearm simulator systems are connected to an apparatus deploying an embodiment of the system. Those systems send real time firearm function information, including but not limited to round fired, charging handle positions, cover state, loaded state, and orientation, into the simulator data interface which can tracks rounds fired and interrupts the firing sequence when the simulator ceases a simulation. The simulator data interface receives the real time firearm function information, and can also accept a variable number of additional circuit inputs requisite to the simulated firearm platforms functional requirements.

Embodiments of the system can be configured to various weapon profiles, and tune the physical weapon effects to each individual weapon system. It should be appreciated that the profiles for a particular firearm simulator can be revised to more accurately reflect the corresponding genuine firearm. As a result, the firearm simulator looks, feels, and sounds like the genuine firearm, creating a significantly more effective device for training purposes.

### DESCRIPTION OF THE DRAWINGS

FIG. 1 shows a system block diagram of one embodiment of the present approach.

FIG. 2 is a photograph of a prototype firearm simulator having a simulation control module connected in the ammunition can.

### DETAILED DESCRIPTION

The following paragraphs illustrate features of embodiments of the present approach, in sufficient detail to enable practice of the present approach. Although the present approach is described with reference to these specific embodiments, it should be appreciated that the present approach may be embodied in different forms, and this description should not be construed as limiting any appended claims to the specific embodiments set forth herein.

Some embodiments of the present approach may take the form of a firearm simulation device having a housing, a trigger assembly connected to the housing, a barrel extending from the housing, a haptics module, a visual module, an audio module, a rate of fire selector switch, an electronic controller configured to receive an activation signal from the trigger assembly and to execute one or more of the haptics module, the visual module, and the audio module, upon the activation signal; a simulation data interface configured to receive and store simulated firearm function data from the electronic controller, and a power supply configured to provide power to the first firearm simulation device. The power supply may receive power from, e.g., an onboard battery or an external power source, among other power sources known and used in the art.

In some embodiments, the haptics module may store or include haptics instructions, which may be computer-readable software for activating and/or controlling one or more elements of or connected to the haptics module. The haptics module in some embodiments may be configured to provide blowback, muzzle rise, and/or recoil. For example, the haptics instructions may provide instructions for the electronic controller to activate a bolt assembly, including, e.g., the speed or force of bolt movement, the frequency of bolt movement, muzzle rise, and the like. The haptics module may, for example, include an electric coil configured to apply a linear electromagnetic force on a weighted rod moveable within the coil against a spring. In such embodiments, the spring expands to force the weighted rod to a starting position when the electric coil is unpowered. In some embodiments, the coil, the weighted rod, and/or the spring may be replaceable to allow for modifying the recoil force, blowback, muzzle rise, and/or recoil, to simulate various aspects of a firearm discharge event.

In some embodiments, the visual module may store or include visual instructions, which may be computer-readable software for activating and/or controlling one or more elements of or connected to the visual module. For example, the visual instructions may provide instructions for the electronic controller to activate an LED, including, e.g., the color, the intensity, and/or the duration of the emitted light. As another example, the visual instructions may provide instructions for the electronic controller to activate a water vapor outlet and emit an ionized water vapor, separately or in connection with emitting light. In some embodiments, the haptics instructions, the visual instructions, and/or the audio instructions, may be configured to simulate a firearm discharge event for a selected firearm. In some embodiments, the haptics instructions, the visual instructions, and/or the audio instructions may be modified to enable simulating firearm discharge events for more than one selected firearm.

In some embodiments, the audio module may store or include audio instructions, which may be computer-readable software for activating and/or controlling one or more elements of or connected to the audio module. For example, the audio instructions may provide instructions for the electronic controller to activate a firearm discharge sound.

Some embodiments may have a haptics module that includes a bolt system configured to activate a bolt assembly and generate a recoil force in the housing. The bolt assembly may be gas-powered, such that movement of the bolt is generated by compressed gas. In some embodiments the bolt assembly may be activated using a magnetic coil and spring, such that movement of the bolt is generated by magnetic and spring forces. Bolt movement generates a recoil force that simulates a firearm discharge event.

It should be appreciated that the housing in some embodiments may be configured to approximate the size and shape of a firearm receiver. For example, the housing may be shaped and sized to appear like the receiver of a specific firearm.

In some embodiments the barrel includes at least one LED configured to emit light that simulates a firearm discharge event. The LED may be positioned at or near the muzzle, along the barrel, or at multiple locations, depending on the embodiment and the firearm being simulated. In some embodiments, the barrel may have a water vapor outlet configured to emit a muzzle flare effect. For example, ionized water may be emitted to simulate smoke exiting the barrel upon a firearm discharge event, and/or to provide additional illumination effects such as muzzle flare effect simulates a firearm discharge event.

In some embodiments, the housing may include at least one speaker system configured to emit a firearm discharge sound. The audio module and/or another component may store one or more electronic audio files that can be played to simulate the sound(s) associated a firearm discharge event. The speaker system may include one or more amplifiers and/or bass units, depending on the desired sound effects.

In some embodiments, the speaker system may be configured to emit the firearm discharge sound in sequence with a bolt assembly activation. For example, the firearm discharge sound may be activated prior to bolt movement to simulate a selected firearm. As another example, the firearm discharge sound can be activated after a bolt assembly activation to simulate a suppressed firearm. In some embodiments, bolt assembly activation, light emittance, muzzle flare effect, and firearm discharge sounds occur in a sequence configured to simulate a firearm discharge event. It should be appreciated that the sequence can be modified to simulate a selected firearm.

In some embodiments of the present approach, the electronic controller may be configured to receive simulated firearm profile data for a selected firearm, and modify at least one of the haptics instructions, the visual instructions, and the audio instructions, to simulate the selected firearm.

Some embodiments of the present approach may generate and store simulated firearm function data, such as, e.g., total rounds fired, activation signal timing, charging handle position, cover state, loaded state, orientation, and the like. Such embodiments may use the store simulated firearm function data for assessing user performance, identifying behaviors for training, generating new training scenarios, and the like.

It should be appreciated that some embodiments may feature different combinations and/or configurations of elements described herein. For example, some embodiments of a firearm simulation device may include a housing, a trigger assembly connected to the housing, a barrel extending from the housing and having at least one LED configured to emit light when activated, a haptics module having a bolt system configured to activate a bolt assembly and generate a recoil force in the housing when activated, a visual module connected to the at least one LED and a fisheye lens reflector and a water vapor outlet configured to emit an ionized water vapor and illuminate the at least one LED when activated to create a muzzle flare effect, an audio module connected to at least one speaker system configured to emit a firearm discharge sound when activated, an electronic controller configured to receive an activation signal from the trigger assembly, activate at least one of the haptics module, the visual module, and the audio module; and a power supply configured to provide power to the first firearm simulation device.

In some embodiments, the electronic controller may be configured to generate simulated firearm function data comprising at least one of total rounds fired, activation signal timing, charging handle position, cover state, loaded state, and orientation. Some embodiments may include a simulation data interface configured to receive and store simulated firearm function data from the electronic controller. The electronic controller may be configured to activate each of the haptics module, the visual module, and the audio module upon receiving the activation signal. Some embodiments may include a rate of fire selector switch configured to modify the frequency of the activation signal. And in some embodiments, the electronic controller may be configured to activate the bolt assembly activation, the light emittance, the muzzle flare effect, and the firearm discharge sound occur in a sequence configured to simulate a firearm discharge event.

The E-Sim Fire system, an embodiment of the present approach, enables realistic physical weapon effects (e.g., haptic, audio, visual), when a user presses the trigger of a connected simulation weapon or firearm simulator. The terms simulation weapon and firearm simulator are used interchangeably, and refer to simulation weapons and firearms that provide one or more physical weapon effects, such as blowback, recoil, cartridge ejection, muzzle flash, muzzle rapport, and so on, but without the discharge of bullets or other potentially dangerous effects. Firearm simulators are especially useful for training military and law enforcement in various scenarios, providing a more realistic environment. The E-Sim Fire system and other embodiments of the present approach advantageously enhance the realism through the integration of realistic physical weapon effects that may be modified or tuned to different simulation weapons and different conditions. In some embodiments, the firearm simulator may be armed or disarmed from the simulation data interface, marking the firearm simulator as destroyed or out of ammo. In such a scenario, activation of the trigger will not cause a fire event.

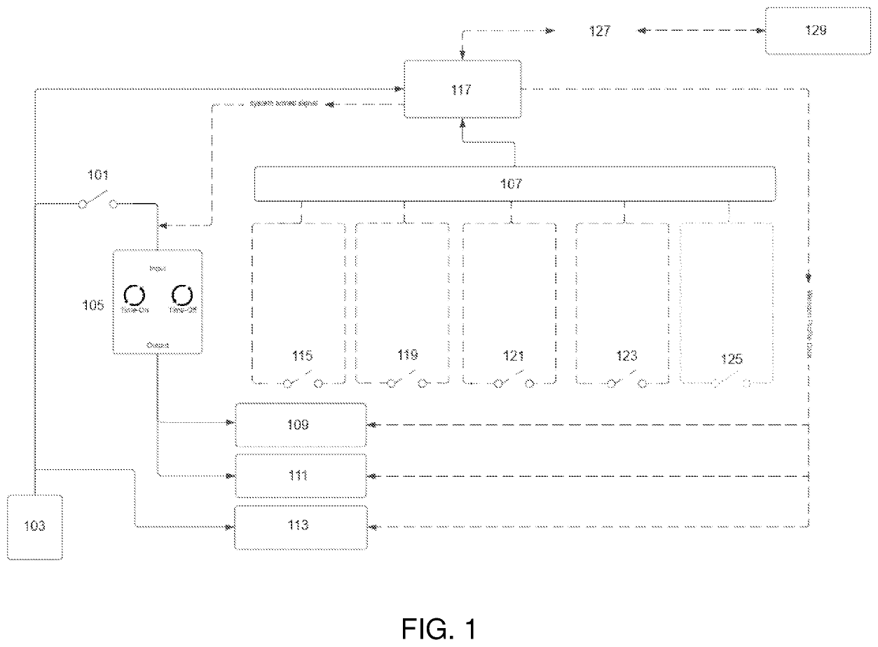

In some embodiments, the system comprises an apparatus attached to, integrated with, and/or built into a firearm simulator. FIG. 1 illustrates a block diagram of an embodiment of the present approach. As illustrated, the system comprises an apparatus having a trigger mechanism or switch 101, a power supply 103, a rate of fire control 105, a simulation data interface 107, and one or more modules 109, 111, and 113. Some embodiments further include one or more circuits, such as described herein.

In the demonstrative embodiment of FIG. 1, activating the trigger 101 on the firearm simulator closes a circuit that, in turn, provides power through a rate of fire control 105. The rate of fire control 105 activates the Haptics module 109 and the Visual module 111, based on the selected or pre-defined rate of fire (e.g., single fire, semi-automatic fire, automatic fire). It should be appreciated that the rate of fire can be selected to replicate the actual rate of fire for the corresponding genuine firearm by controlling the on and off values on the rate of fire control. The Haptics module 109 can, in some embodiments, close the fire circuit 115 after activation to send fire event to the simulator control module 117. Other circuits may include, e.g., a top cover circuit 119, a rounds loaded circuit 121, a charging handle circuit 123, and other circuits 125. The simulator control module 117 then, in turn, activates the Audio module 113 to produce one or more sound effects in time with the Haptics module 109 activity and the Visual module 111 activity.

Embodiments of the system send real time firearm function information into a simulation data interface 127, the data including, but not limited to, round fired, charging handle positions, cover state, loaded state, and orientation. It should be appreciated that other data may be included, and that some embodiments may involve fewer or different data, or different combinations of data, without departing from the present approach. The simulation data interface 127 may, in some embodiments, be built to accept a variable number of addition additional circuit inputs 125, such as may be requisite to the simulated firearm platforms functionally requirements. The simulation data interface 127 then transmits the firearm function information to the simulation control module, for operating the various physical effect modules (e.g., haptics, audio, visual). In some embodiments,

[symbol]

Some embodiments of the system can be configured to various weapon profiles, such that the system simulates physical weapon effects specific to the particular firearm simulator. Firearm simulator profiles, containing the Haptics, Visual, and Audio module configurations for a specific firearm simulator, may be stored either locally on the firearm simulator, or in the simulator control module. In some embodiments, the system may be configured to allow a user to tune one or more of the physical weapon effects for a particular firearm simulator weapon system. For example, if a firearm simulator includes a muzzle suppressor, then certain simulated physical weapon effects, such as the acoustic intensity of the muzzle report, muzzle rise, and muzzle flash, may be reduced to more accurately simulate the operation of a suppressed firearm. In some embodiments, the system may also adjust components such as muzzle exit velocity, bullet yaw, and bullet drag, to simulate the impact of a suppressor on a firearm simulator. Embodiments may deploy a profile of physical weapon effects for a particular suppressor, such that the effects of different suppressors may be simulated. In some embodiments, the physical weapon effects may be calculated onboard the firearm simulator, and in other embodiments, the physical weapon effects may be calculated at an external simulation. In either alternative, the effect of the fire event may then be determined.

The following paragraphs describe the firing process according to embodiments of the present approach. The system includes one or more firearm simulators, and one or more modules as described below. When the trigger 101 on the firearm simulator is activated, a circuit closes, which in turn sends power into a rate of fire control 105 which powers the various weapon effect modules 109-113 at a variable cycle rate. The rate of fire control 105 enables the user to adjust the on and off time of the cycle, thereby tuning the cycle rate to a specific weapon profile the system is mounted on. It should be appreciated that in some embodiments, the present approach includes one or more devices that may be attached to the firearm simulator to provide the physical effects (e.g., haptics, audio, visual modules). In some embodiments, one or more of the physical effects modules may be built into the firearm simulator.

Some embodiments include a Haptics module 109. The cycle power controlled from the rate of fire control 105 powers the Haptics module 109, which simulates the bolt movement of the simulated firearm. It should be appreciated that the bolt assembly may be gas-powered, such that compressed gas drives bolt movement. In other embodiments, the bolt assembly may be powered using a magnetic coil and spring acting on a bolt. In such embodiments, electrifying a coil generates an electromagnetic force that pulls a weighted rod with linear force through the coil. The rod has an attached weight element on the end that pull against a spring between the coil and the weight element. When the coil is unpowered, the compressed spring expands to return the simulated bolt to the natural position. This Haptics module 109 can be sized to simulate different firearm simulators, e.g., for different movement forces, by changing the size of the coil, size of the weight, and resistance of the spring, among other examples. It should be appreciated that the person having an ordinary level of skill can modify the Haptics module 109 in various ways without departing from the present approach. Similarly, the Haptics module 109 may be configured to operate in different ways, providing blowback or other bolt action effects, muzzle rise, recoil, etc., without departing from the present approach. Additionally, multiple Haptics modules 109 can be used (e.g., in a series) to increase or otherwise manipulate the force of the physical recoil effect.

Some embodiments include a Visual module 111. The Visual module 111 simulates the visual signature of the simulated fire event, such as a muzzle flash. The Visual module 111 in the E-Sim Fire embodiment generates visual signatures through a combination white and amber LEDs, and fisheye lens reflectors mounted inside of the firearm's flash suppressor. In addition, embodiments of the system can be configured to create a 3D volumetric muzzle flash effect by pushing a water vapor cloud for LEDs to light in time with the weapon firing cycle.

Some embodiments include an Audio module 113. It should be appreciated that the Audio module 113 is configured to generate sounds corresponding to a firing event, such that activation of the firearm simulator's trigger causes an associated firing event sound. The Audio module 113 in the E-Sim Fire embodiment simulates the sound of a simulated fire event by sending sound waveforms into an amplifier that powers a physically mounted bass transducer mounted to the firearm simulator. This combines with the sound of the bolt action from the Haptic module 109 to create the overall physical effect of the firearm simulator on the person firing the system. The waveform can be tuned to different weapons to accurately portray the sound of the system by filling in the frequencies around the sound of the haptics module bolt movement. The Audio module 113 may drive by tying into the output of the fire circuit via the simulator control module.

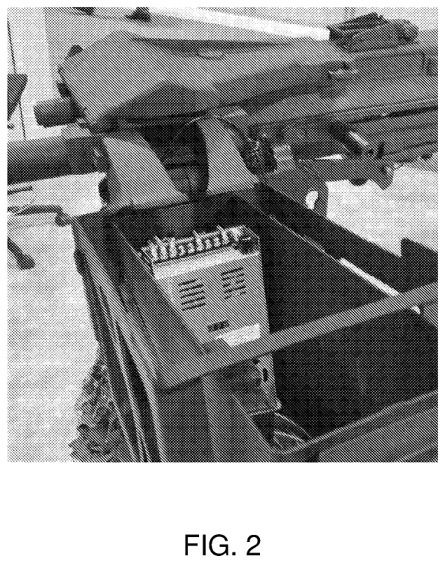

In addition to the fire circuit, the simulator control module 107 can accept any number of simple circuits tied to various weapon system functions such the top cover being open or closed, the system having rounds loaded, the position of the charging handles. FIG. 2 is a photograph of a simulator control module connected to a firearm simulator through an ammunition can. The simulator control module can pass data to an external simulation that uses the information to execute the fire event to inform the system and the participants in the simulation of the effect in the fire event from the terrain and simulated elements. For example, the simulation may provide virtual reality or augmented reality overlays that show real time outcomes of fire events, such as whether a target was struck, where a target was struck, calculated round trajectory and placement, response time, etc.

In a rapidly evolving technological landscape, the integration of generative artificial intelligence (AI) has the potential to further enhance the effectiveness and adaptability of the disclosed apparatus, systems, and methods for providing electric powered simulated firearm effects, such as the E-Sim Fire system described herein. Generally, generative AI is capable of generating text, images, or other media, using generative models that learn structure, patterns, and other aspects of input training data, and then generate new data that has similar characteristics to the training data.

In some embodiments, the E-Sim Fire system can interface seamlessly with generative AI systems. By leveraging generative AI, such embodiments can dynamically adapt and enhance simulation scenarios based on real-time performance data captured within the simulation. This integration allows for a wide range of possible scenarios for optimizing training experiences and fine-tuning the realism of firearm simulations.

Generative AI algorithms can analyze the actions and decisions of trainees within the simulation and capture a wide range of performance data. Such data may include, but is not limited to, accuracy, reaction times, weapon handling, and decision-making patterns. The generative AI can then use this data to generate scenarios that challenge trainees in areas where improvement is needed, creating a tailored and adaptive training curriculum.

For example, if a trainee consistently exhibits weaknesses in accuracy during simulated engagements, the generative AI can introduce scenarios that emphasize accuracy training, such as high-stress situations or moving targets. Conversely, if a trainee excels in one aspect of firearm operation, the AI can adjust scenarios to maintain an appropriate level of challenge.

Furthermore, the integration with generative AI enables embodiments of the E-Sim Fire system to evolve and stay up-to-date with the latest advancements in firearm technology and tactics. The generative AI can analyze current firearm trends and incorporate this knowledge into the simulation, ensuring that trainees are exposed to the most relevant and realistic training scenarios. Including the capacity of E-Sim Fire system to interface with generative AI and leverage performance data captured within the simulation represents a pivotal advancement in firearm training technology. This adaptive and data-driven approach not only enhances the realism of training but also ensures that trainees receive targeted and effective instruction, thereby improving their overall firearm proficiency.

It should be appreciated that the present approach significantly enhances the realism of simulated firearms. Embodiments such as the E-Sim enhance firearm training by providing more realistic simulations of firearm use. The present approach is highly valuable for military, law enforcement, and civilian firearm training industries, as it allows trainees to experience realistic scenarios without the risks associated with live ammunition.

Further, the present approach provides significant safety and cost savings. By providing realistic firearm effects without the need for live ammunition, embodiments can significantly improve safety during training sessions. The present approach also reduces the cost associated with using live ammunition, making it an attractive option for organizations seeking cost-effective and safe training solutions.

The present approach provides an array of tunable haptics, visual, and audio parameters for simulating the properties of different firearms. The ability to configure an embodiment to various weapon profiles and tune physical effects to individual weapon systems can make it versatile and adaptable to different training needs. This customization feature can attract a wider range of potential customers.

Embodiments may be integrated with various simulation data. The external simulation data interface can enable integration with various simulation scenarios and environments, potentially expanding the application of embodiments of the present approach beyond standard firearm training to broader simulation and training contexts.

The present approach combines haptic, audio, and visual effects to create a more immersive and realistic firearm simulation. The integration of these elements in a single system has not been achieved in prior attempts to provide simulated firearms.

It should be appreciated that including an external simulation data interface allows for compatibility with a wide range of simulation scenarios and environments, potentially expanding the use of the technology beyond firearm training.

As will be appreciated by one of skill in the art, aspects or portions of the present approach may be embodied as a method, system, and at least in part, on a computer readable medium. Accordingly, the present approach may take the form of combination of hardware and software embodiments (including firmware, resident software, micro-code, etc.) or an embodiment combining software and hardware aspects that may all generally be referred to herein as a “circuit,” “module” or “system.” Furthermore, the present approach may take the form of a computer program product on a computer readable medium having computer-usable program code embodied in the medium. The present approach might also take the form of a combination of such a computer program product with one or more devices, such as a modular sensor brick, systems relating to communications, control, an integrate remote control component, etc.

Any suitable non-transient computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the non-transient computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a device accessed via a network, such as the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any non-transient medium that can contain, store, communicate, propagate, or transport the program for use by or in connection with the instruction execution system, apparatus, or device.

Computer program code for carrying out operations of the present approach may be written in an object oriented programming language such as Java, C++, etc. However, the computer program code for carrying out operations of the present approach may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present approach is described below with reference to flowchart illustrations and/or block diagrams of methods, apparatus (systems) and computer program products according to embodiments of the approach. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable memory, including a networked or cloud accessible memory, that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to specially configure it to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present approach may be presented and responded to via a graphical user interface (GUI) presented on the display of the mobile communications device or the like. Prompts may also be audible, vibrating, etc. Any flowcharts and block diagrams in the Figures illustrate the architecture, functionality, and operation of possible implementations of systems, methods and computer program products according to various embodiments of the present approach. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for describing particular embodiments only and is not intended to be limiting of the approach. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present approach may be embodied in other specific forms without departing from the spirit or essential characteristics thereof. The present embodiments are therefore to be considered in all respects as illustrative and not restrictive, the scope of the present approach being indicated by the claims of the application rather than by the foregoing description, and all changes which come within the meaning and range of equivalency of the claims are therefore intended to be embraced therein.

1. A firearm simulation device comprising:
a housing,
a trigger assembly connected to the housing,
a barrel extending from the housing,
a haptics module storing haptics instructions,
a visual module storing visual instructions,
an audio module storing audio instructions,
a rate of fire selector switch,
an electronic controller configured to receive an activation signal from the trigger assembly, haptics instructions from the haptics module, visual instructions from the visual module, audio instructions from the audio module, and a rate of fire selection from the rate of fire selector switch; and to execute haptics instructions, visual instructions, and audio instructions upon the activation signal;
a simulation data interface configured to receive and store simulated firearm function data from the electronic controller, and
a power supply configured to provide power to the first firearm simulation device.

2. The firearm simulator of claim 1, wherein the haptics module further comprises a bolt system configured to activate a bolt assembly and generate a recoil force in the housing based on at least one of a trigger assembly activation, a rate of fire selector switch position, and the haptics module, wherein the recoil force simulates a firearm discharge event.

3. The firearm simulator of claim 1, wherein the housing is configured to approximate the size and shape of a firearm receiver.

4. The firearm simulator of claim 1, wherein the barrel further comprises at least one LED configured to emit light based on at least one of a trigger assembly activation, a rate of fire selector switch position, the haptics module, and the visual module, wherein the emitted light simulates a firearm discharge event.

5. The firearm simulator of claim 1, wherein the barrel further comprises a water vapor outlet configured to emit a muzzle flare effect based on at least one of a trigger assembly activation, a rate of fire selector switch position, the haptics module, and the visual module, wherein the muzzle flare effect simulates a firearm discharge event.

6. The firearm simulator of claim 1, wherein the housing further comprises at least one speaker system configured to emit a firearm discharge sound based on at least one of a trigger assembly activation, the rate of fire selector switch position, the haptics module, and the audio module, the firearm discharge sound simulating a firearm discharge event.

7. The firearm simulator of claim 6, wherein the speaker is configured to emit the firearm discharge sound in sequence with a bolt assembly activation.

8. The firearm simulator of claim 6, wherein the bolt assembly activation, the light emittance, the muzzle flare effect, and the firearm discharge sound occur in a sequence configured to simulate a firearm discharge event.

9. The firearm simulator of claim 1, wherein at least one of the haptics instructions, the visual instructions, and the audio instructions, are configured to simulate a firearm discharge event for a selected firearm.

10. The firearm simulator of claim 9, wherein the electronic controller is configured to receive simulated firearm profile data for a selected firearm, and modify at least one of the haptics instructions, the visual instructions, and the audio instructions, to simulate the selected firearm.

11. The firearm simulator of claim 1, wherein the power supply receives power from at least one of a battery and an external power source.

12. The firearm simulator of claim 1, wherein the haptics module further comprises an electric coil configured to apply a linear electromagnetic force on a weighted rod moveable within the coil against a spring, wherein the spring expands to force the weighted rod to a starting position when the electric coil is unpowered.

13. The firearm simulator of claim 12, wherein at least one of the coil, the weighted rod, and the spring are configured for replacement to modify the recoil force.

14. The firearm simulator of claim 1, wherein the haptics module is configured to provide at least one of blowback, muzzle rise, and recoil based on at least one of a trigger assembly activation, a rate of fire selector switch position, and the haptics module.

15. The firearm simulator of claim 1, wherein the simulated firearm function data comprises at least one of total rounds fired, activation signal timing, charging handle position, cover state, loaded state, and orientation.

16. A firearm simulation device comprising:
a housing;
a trigger assembly connected to the housing;
a rate of fire selector switch connected to the housing;
a barrel extending from the housing and having at least one LED configured to emit light when activated;
a haptics module having a bolt system configured to activate a bolt assembly and generate a recoil force in the housing when activated;
a visual module connected to the at least one LED and a fisheye lens reflector and a water vapor outlet configured to emit an ionized water vapor and illuminate the at least one LED when activated to create a muzzle flare effect;
an audio module connected to at least one speaker system configured to emit a firearm discharge sound when activated;
an electronic controller configured to receive an activation signal from the trigger assembly, activate at least one of the haptics module, the visual module, and the audio module; and
a power supply configured to provide power to the first firearm simulation device.

17. The firearm simulator of claim 16, wherein the electronic controller is further configured to generate simulated firearm function data comprising at least one of total rounds fired, activation signal timing, charging handle position, cover state, loaded state, and orientation;
and further comprising a simulation data interface configured to receive and store simulated firearm function data from the electronic controller.

18. The firearm simulator of claim 16, wherein the electronic controller is configured to activate each of the haptics module, the visual module, and the audio module upon receiving the activation signal.

19. The firearm simulator of claim 16, further comprising a rate of fire selector switch configured to modify the frequency of the activation signal.

20. The firearm simulator of claim 16, wherein the electronic controller is configured to activate the bolt assembly activation, the light emittance, the muzzle flare effect, and the firearm discharge sound occur in a sequence configured to simulate a firearm discharge event.
